(19) United States
(12) Patent Application Publication
(10) Pub. No.: US 2024/0195350 A1
(43) Pub. Date: Jun. 13, 2024

(54) FASTENING TOOL AND FASTENING DEVICE

(71) Applicant: TAKASHIMA & CO., LTD., Chiyoda-ku (JP)

(72) Inventors: Takayuki Kanbara, Anjyo-Shi (JP); Masaki Kishimoto, Anjyo-Shi (JP)

(73) Assignee: TAKASHIMA & CO., LTD., Chiyoda-ku (JP)

(21) Appl. No.: 18/584,683

(22) Filed: Feb. 22, 2024

Related U.S. Application Data
(63) Continuation of application No. PCT/JP2022/017271, filed on Apr. 7, 2022.

(30) Foreign Application Priority Data
Apr. 23, 2021 (WO) PCT/JP2021/030842

(51) Int. Cl. H02S 30/10; H02S 20/23

(52) U.S. Cl. CPC H02S 30/10; H02S 20/23

(57) ABSTRACT

A fastening tool for attaching a plate-shaped photovoltaic module includes a support member on which a photovoltaic module is mounted and which is arranged on a mounting target object; a pressing member having a base portion fastened to the mounting target object by a fastening member via the support member and a regulating portion arranged on the base portion to regulate the movement of the photovoltaic module in a direction away from the mounting target object; and a deformation portion in a posture of being tilted with respect to the base portion, and if the base portion is fastened to the mounting target object by the fastening member, the deformation portion is pressed and deformed by the base portion, which brings the regulating portion into a posture that regulates the movement of the photovoltaic module in the direction away from the mounting target object.

### CROSS-REFERENCE TO RELATED APPLICATION

This application is a Continuation application of PCT Application No. PCT/JP2022/017271, filed Apr. 7, 2022 and based upon and claiming the benefit of priority from PCT Application No. PCT/JP2021/030842, filed Aug. 23, 2021, the entire contents of all of which are incorporated herein by reference.

### FIELD

The present invention relates to a fastening tool and a fastening device for fastening photovoltaic modules to a target installation position.

### BACKGROUND

Photovoltaic power generation systems for generating power with multiple photovoltaic modules fastened, for example, to the rooftop of a house have been known. As a technique for fastening such photovoltaic modules to the rooftop, Jpn. Pat. Appln. KOKAI Publication No. 2018-109322 discloses a technique of securing a base member between two photovoltaic modules adjacent to each other on the rooftop and fastening to this base member a pressing member for pressing the edges of the two adjacent photovoltaic modules with bolts and nuts.

### CITATION LIST

### Patent Literature

[Patent Document 1] Jpn. Pat. Appln. KOKAI Publication No. 2018-109322

### SUMMARY

According to an embodiment, a fastening tool is configured to attach a plate-like photovoltaic module to a mounting target object, and includes a support member, a pressing member, and a deformation portion. The support member is configured to carry the photovoltaic module thereon and is arranged on the mounting target object. The pressing member includes a base portion fastened to the mounting target object by a fastening member by way of the support member, and a regulating portion provided on the base portion and regulating the movement of the photovoltaic module in a direction away from the mounting target object. The deformation portion is provided between the base portion and the mounting target object in a posture tilted with respect to the base portion, and if the base portion is fastened to the mounting target object by the fastening member, the deformation portion is pressed and deformed by the base portion, and the regulating portion is brought into a posture that regulates the movement of the photovoltaic module in a direction away from the mounting target object.

### BRIEF DESCRIPTION OF THE DRAWINGS

FIG. 1 is an exploded perspective view showing a photovoltaic power generation system adopting a fastening device according to the first embodiment of the present invention.

FIG. 2 is a cross-sectional view showing the photovoltaic power generation system.

FIG. 3 is a perspective view showing the fastening device.

FIG. 4 is a perspective view showing a base member and a support member of the fastening device.

FIG. 5 is a perspective view showing the base member.

FIG. 6 is a plan view showing the base member.

FIG. 7 is a front view showing the base member.

FIG. 8 is a cross-sectional view showing the fastening device in a tentatively fastened state.

FIG. 9 is a side view showing the fastening device according to a modification example.

FIG. 10 is a side view showing the fastening device according to a modification example.

FIG. 11 is a side view showing the fastening device according to a modification example.

FIG. 12 is a cross-sectional view showing a photovoltaic power generation system according to the second embodiment of the present invention.

FIG. 13 is a perspective view showing a fastening device of the photovoltaic power generation system.

FIG. 14 is a cross-sectional view showing the fastening device in a tentatively fastened state.

FIG. 15 is a cross-sectional view showing a modification example of the photovoltaic power generation system.

FIG. 16 is a perspective view showing a fastening device of the photovoltaic power generation system according to a modification example.

FIG. 17 is a cross-sectional view showing the fastening device in a tentatively fastened state.

FIG. 18 is a cross-sectional view showing a photovoltaic power generation system according to the third embodiment of the present invention.

FIG. 19 is a front view showing a base member of the photovoltaic power generation system.

FIG. 20 is a cross-sectional view showing the fastening device and the eaves-side fastening device in a tentatively fastened state.

FIG. 21 is a cross-sectional view showing a photovoltaic power generation system according to the fourth embodiment of the present invention.

FIG. 22 is a perspective view showing a pressing member of the photovoltaic power generation system.

FIG. 23 is a cross-sectional view showing the pressing member.

FIG. 24 is a cross-sectional view showing the fastening device in a tentatively fastened state.

FIG. 25 is a cross-sectional view showing the fastening device according to a modification example.

FIG. 26 is a cross-sectional view showing a photovoltaic power generation system according to the fifth embodiment of the present invention.

FIG. 27 is a perspective view showing the fastening device.

FIG. 28 is a perspective view showing a base member and a support member of the fastening device.

FIG. 29 is a cross-sectional view showing the fastening device in a tentatively fastened state.

FIG. 30 is a perspective view of a support member of the fastening device.

### DETAILED DESCRIPTION

According to an embodiment, a fastening tool is configured to attach a plate-like photovoltaic module to a mounting target object, and includes a support member, a pressing member, and a deformation portion. The support member is configured to carry the photovoltaic module thereon and is arranged on the mounting target object. The pressing member includes a base portion fastened to the mounting target object by a fastening member by way of the support member, and a regulating portion provided on the base portion and regulating the movement of the photovoltaic module in a direction away from the mounting target object. The deformation portion is provided between the base portion and the mounting target object in a posture tilted with respect to the base portion, and if the base portion is fastened to the mounting target object by the fastening member, the deformation portion is pressed and deformed by the base portion, and the regulating portion is brought into a posture that regulates the movement of the photovoltaic module in a direction away from the mounting target object.

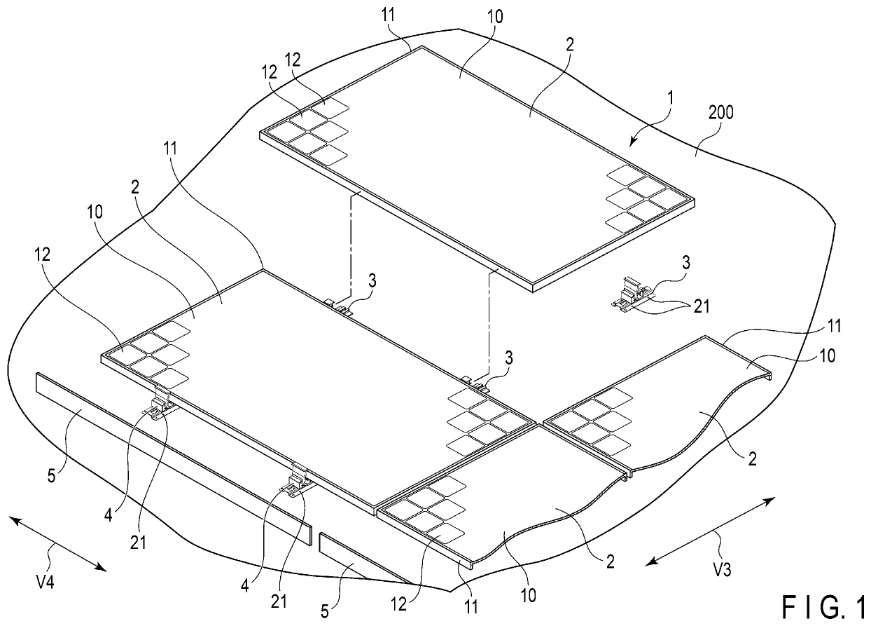

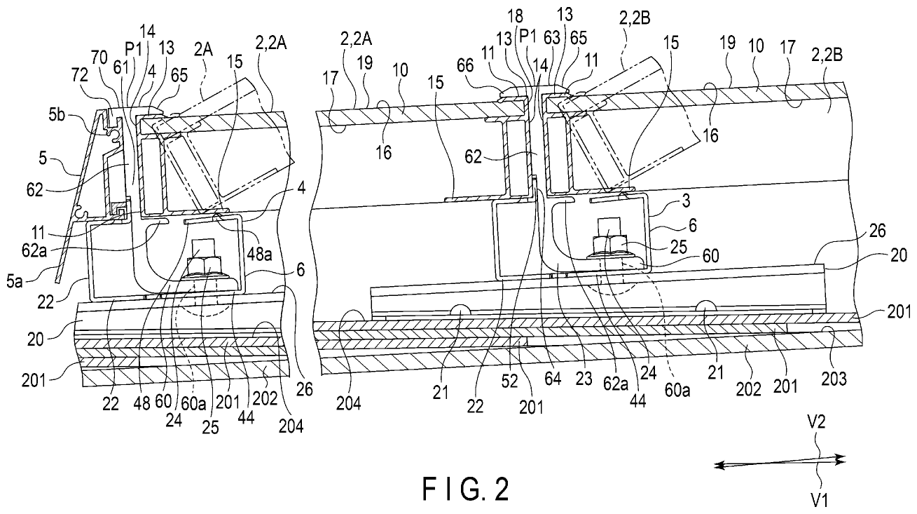

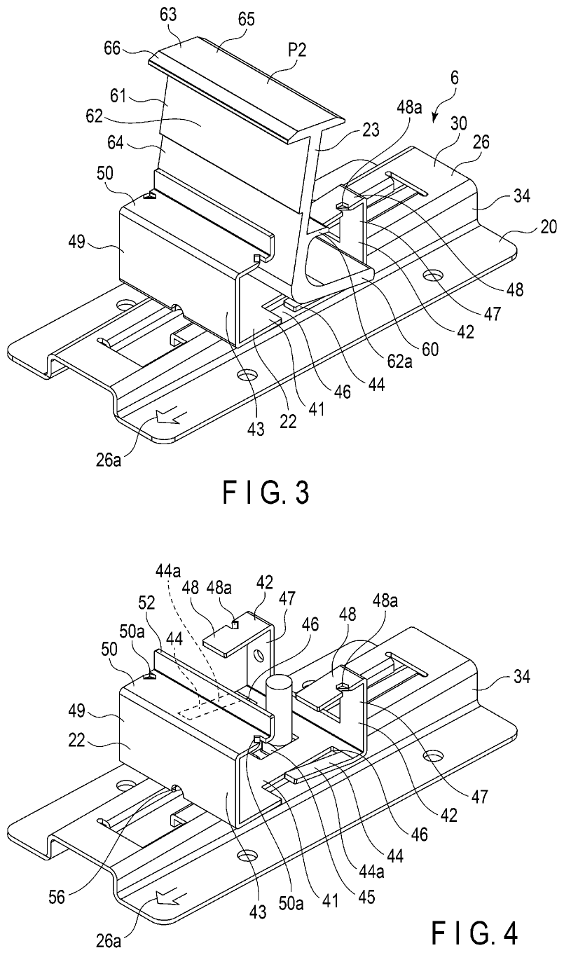

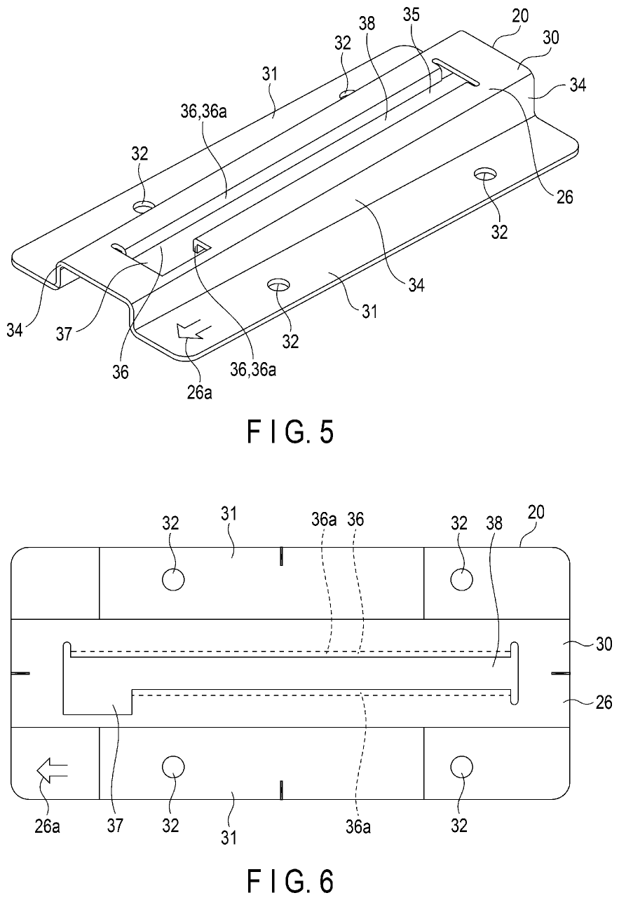

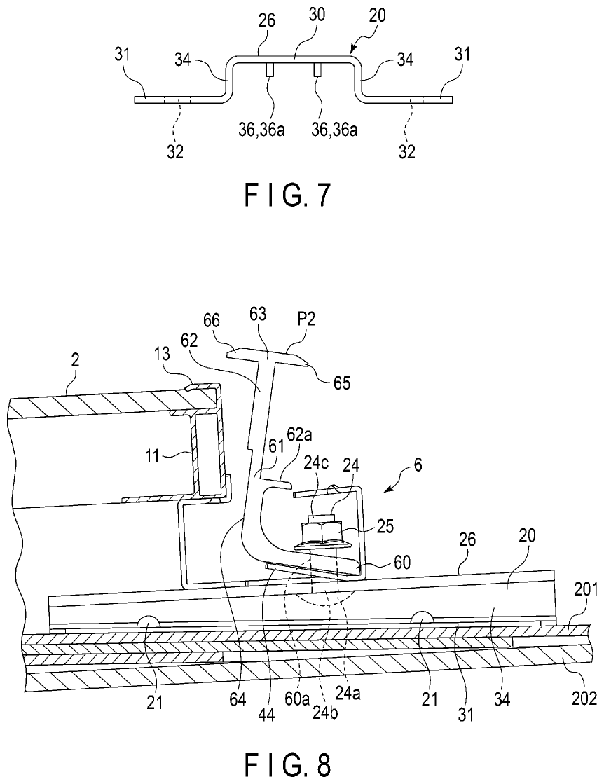

A fastening device 3 according to the first embodiment of the present invention will be described with reference to FIGS. 1 to 8. FIG. 1 is an exploded perspective view showing a photovoltaic power generation system 1. FIG. 2 is a cross-sectional view showing the photovoltaic power generation system 1, where the ridge side is the right side of the sheet, and the eaves side is the left side. FIG. 3 is a perspective view showing the fastening device 3, and FIG. 4 is a perspective view showing the base member 20 and the support member 22 of the fastening device 3. FIG. 5 is a perspective view of the base member 20, FIG. 6 is a plan view of the base member 20, and FIG. 7 is a front view of the base member 20. FIG. 8 is a cross-sectional view showing the fastening device 3 in a tentatively fastened state, where the ridge side is the right side of the sheet and the eaves side is the left side.

As illustrated in FIG. 1, the photovoltaic power generation system 1 is installed, as an exemplary installation place, on a roof 200 of a house. As illustrated in FIG. 2, the roof 200 may include a plurality of roofing members 201. The roofing members 201 may be slates. These roofing members 201 are arranged on the upper surface 203 of the roof board 202. The ridge-side end portion of a roofing member 201 is placed on the roof board 202, while the eaves-side end portion thereof is imbricated on another roofing member 201 on the eaves side thereof. The first direction V1, which is the direction of the upper surface 204 of the roofing member 201 tilted with respect to the vertical direction, intersects the second direction V2, which is the direction of the upper surface 203 of the roof board 202 tilted with respect to the vertical direction.

As shown in FIG. 1, the photovoltaic power generation system 1 includes a plurality of photovoltaic modules 2, a plurality of fastening devices 3, a plurality of eaves-side fastening devices 4, and a plurality of decorative panels 5. The photovoltaic modules 2 are mounted on the roof 200 by the fastening devices 3 and the eaves-side fastening devices 4. The photovoltaic modules 2 may be arranged in both the third direction V3, which is parallel to a direction from the ridge to the eaves, and the fourth direction V4, which is orthogonal to the third direction V3. The number of photovoltaic modules 2 is suitably determined in accordance with the size of the installation place, the targeted output, and the like.

A photovoltaic module 2 is shaped into a plate. The photovoltaic module 2 includes, for example, a solar panel 10 and a frame 11. The solar panel 10 is prepared by integrally attaching together a plurality of cells 12 that are constituted of solar cell elements and forming them into a plate. The solar panel 10 may be formed, for example, into a rectangular plate.

As shown in FIG. 2, the frame 11 is provided at the edge portion of the solar panel 10. In FIG. 2, the cross section of the photovoltaic module 2 is illustrated. The frame 11 includes a base part formed of a conductive metal material and a protective layer provided on the surface of the base part for corrosion prevention. The protective layer may be formed by plating this base part.

The frame 11 includes, for example, an upper surface portion 13, a side surface portion 14, and a lower surface portion 15. The upper surface portion 13 is formed to surround the edge of the upper surface 16, the edge of the lower surface 17, and the side surface 18 of the solar panel 10. The side surface portion 14 extends downward from the upper surface portion 13. The lower surface portion 15 extends from the lower end of the side surface portion 14 toward the inside of the frame 11.

As shown in FIGS. 1 and 2, the fastening device 3 may be provided between two photovoltaic modules 2 mutually adjacent in the third direction V3. The fastening device 3 fastens the two adjacent photovoltaic modules 2 to the roof 200.

As shown in FIGS. 2 and 3, the fastening device 3 includes, for example, a base member 20, a fastening member 21 for fastening the base member 20 to the roof 200, a fastening tool 6, and a bolt 24 and a nut 25 that serve as a fastening member for fastening the fastening tool 6 to the base member 20.

The base member 20 is an example of a mounting target object on which the photovoltaic module 2 is mounted. The base member 20 is formed into a shape elongated in one direction, for example, the third direction V3 when fastened to the roof 200. The length of the base member 20 in the longitudinal direction is determined to be shorter than that of the photovoltaic module 2 in the third direction V3. The upper surface 26 of the base member 20 is formed into a plane that becomes parallel to the upper surface 203 of the roof board 202 when the base member 20 is fastened to the roof 200. The roof board 202 is an example of a base component of the roof 200 on which the roofing members 201 are provided. The base member 20 is formed such that its upper surface 26 becomes a plane parallel to the upper surface of this base component.

For example, as illustrated in FIGS. 2 to 5, 7, and 8, the base member 20 includes a base portion 30, a pair of vertical wall portions 34, and a pair of flanges 31.

The upper surface of the base portion 30 constitutes the upper surface 26 of the base member 20. The upper surface 26 is formed into a flat surface. The base portion 30 is formed into a plate elongated in one direction and includes a groove 35 and a regulating portion 36.

The groove 35 pierces through the base portion 30 and extends along the longitudinal direction of the base portion 30. The groove 35 may be provided at the center with respect to the width direction of the base portion 30, extending from the vicinity of one end of the base portion 30 to the vicinity of the other end in the longitudinal direction. In the groove 35, the screw portion 24c of the bolt 24, which will be described later, can be arranged in a movable manner in the longitudinal direction of the groove 35.

The groove 35 includes a first portion 37 and a second portion 38. The first portion 37 forms, for example, one end portion of the groove 35. The length and width of the first portion 37 with respect to the longitudinal direction of the groove 35 are determined to be dimensions that allow the head portion 24a of the bolt 24, which will be described later, to pass through.

The second portion 38 constitutes the other end portion of the groove 35 with respect to the first portion 37. The length and width of the second portion 38 with respect to the longitudinal direction of the groove 35 are determined to be dimensions that allow the screw portion 24c to be arranged in the second portion 38 but do not allow the head portion 24a to pass through. In the present embodiment, the width of the second portion 38 is determined to be sufficient for the later-described base portion 24b of the bolt 24 to move through. In the second portion 38 having the edges extending along the longitudinal direction with respect to the width direction, one of these edges is linearly continuous with the edge of the first portion 37.

The regulating portion 36 is configured to regulate the rotation of the bolt 24. The regulating portion 36 may be provided in the lower surface of the base portion 30. The regulating portion 36 has, for example, a pair of vertical wall portions 36a at the two edges of the second portion 38 along the longitudinal direction. The distance between these vertical wall portions 36a is determined such that the base portion 24b of the bolt 24 can be arranged in between and that the rotation of the bolt 24 can be regulated with the inner surfaces of the vertical wall portions 36a being in contact with the outer surface of the base portion 24b.

In another example, the regulating portion 36 may be configured by the inner surface of the groove 35. For instance, if the thickness of the base portion 30 is sufficient to receive at least part of the base portion 24b in the groove 35 with the bolt 24 and the nut 25 engaged with each other, the rotation of the bolt 24 can be regulated with the inner surface of the groove 35 being in contact with the base portion 24b.

The vertical wall portions 34 are formed, for example, at the edges of the base portion 30 along the longitudinal direction. The vertical length of the vertical wall portions 34 is determined to be a dimension such that the upper surface 26 becomes a plane parallel to the upper surface 203 of the roof board 202 when the base member 20 is fastened to the roof 200. In the example of the present embodiment, the vertical length of the vertical wall portions 34 is determined to gradually increase from the eaves-side end, or in other words the end on the first portion 37 side, to the other end side.

The pair of flanges 31 are formed at the lower end edges of the outer surfaces of the vertical wall portions 34. The flanges 31 may be formed into a rectangular plate. One or more holes 32 are formed in the flanges 31, through which a fastening member 21 is inserted. The hole 32 may be formed on each of one end side and the other end side of the flanges 31 in the longitudinal direction.

A marking 26a is provided on the base member 20. The marking 26a may be configured by embossed patterns or dents. Alternatively, the marking 26a may be formed by printing. The marking 26a is provided at the end portion on the eaves side or the ridge side of the base member 20 to indicate the eaves-side end portion or the ridge-side end portion of the base member 20. In the present embodiment, for example, the marking 26a may be provided on the eaves-side end portion of the flange 31 to indicate that it is an eaves-side end portion. The marking 26a may be formed into a pattern of characters representing “eaves”, an arrow indicating eaves, or the like.

The fastening member 21 may be a screw. The fastening member 21 is inserted into the hole 32 and engaged with the roofing member 201 and the roof board 202, thereby fastening the base member 20 to the roofing member 201 and the roof board 202.

The fastening tool 6 includes a support member 22 mounted on the base member 20, a pressing member 23 that presses the upper surface portion 13 of the frame 11, which is an example of the upper surface 19 of the photovoltaic module 2, and a biasing portion 44.

The support member 22 is mounted on the upper surface 26 of the base portion 30, as shown in FIGS. 2 to 4. The support member 22 includes a support portion for supporting part of the lower surface of the photovoltaic module 2, which is an example of the main surface of the photovoltaic module 2 on the base member 20 side, for example, part of the edge portion thereof. That is, the support member 22 carries the photovoltaic module 2 and is mounted on the base member 20, as shown in FIGS. 2 to 4. The support member 22 may include a support member base portion (interposed portion) 41, a first support portion 42, a second support portion 43, and a biasing portion 44, as illustrated in FIGS. 3 and 4. The support member 22 may be formed of aluminum, iron, or resin.

The support member base portion 41 is mounted on the upper surface 26 of the base portion 30. The support member base portion 41 may be formed into a rectangular plate, or more specifically, a rectangular plate elongated in the width direction of the base member 20. The length of the support member base portion 41 in the longitudinal direction is greater than the width of the base portion 30. The support member base portion 41 has a hole 45 through which the screw portion 24c of the bolt 24 is arranged. The support member base portion 41 also has holes 46 in each of which a biasing portion 44 is arranged. The holes 46 may be formed on the respective sides of the hole 45. The two holes 46 may pierce through the support member base portion 41 in the thickness direction, and open in the width direction.

Of the two photovoltaic modules 2 adjacent to each other in the third direction V3, the first support portion 42 supports part of the edge portion of the lower surface of the ridge-side photovoltaic module 2. A first support portion 42 may be formed on the ridge side of the support member base portion 41, for example, on each of the two end portions of the ridge-side edge. The first support portion 42 may include a first vertical wall portion 47 and a first mounting portion 48.

The first vertical wall portion 47 is formed into a plate standing upright from the support member base portion 41. The first mounting portion 48 is provided at the upper end of the first vertical wall portion 47, and part of the edge portion of the lower surface of the photovoltaic module 2 can be mounted on the first mounting portion 48. The first mounting portion 48 may be formed into a rectangular plate extending toward the second support portion 43. For instance, the first mounting portion 48 may be tilted toward the distal end of the second support portion 43 on the support member base portion 41 side. The height of the distal end of the first mounting portion 48 from the support member base portion 41 is lower than that of the upper end of the first vertical wall portion 47 from the support member base portion 41. A first protrusion 48a is formed on the upper surface of the first mounting portion 48, and may be formed into a sharp tip. With the photovoltaic module 2 mounted on the first mounting portion 48, the first protrusion 48a breaks through the protection layer on the surface of the frame 11 and comes into abutment on the base part. The first protrusion 48a may be provided on the first vertical wall portion 47 side of the first mounting portion 48. The first vertical wall portion 47 side of the first mounting portion 48 may be one end of the first mounting portion 48 on the first vertical wall portion 47 side or the vicinity of this end. As shown in FIGS. 3 and 4, the first vertical wall portion 47 has a rectangular opening or cutout in the upper part of the center portion thereof. As a result of this, the first vertical wall portion 47 has two rectangular plate portions on the upper side, and a pair of the first mounting portions 48 and the first protrusions 48a are provided so as to be continuous from these plate portions.

The second support portion 43 is provided on the support member base portion 41 to support part of the edge portion of the lower surface of the eaves-side one of the two photovoltaic modules 2 that are aligned in the third direction V3. The second support portion 43 may include a second vertical wall portion 49 and a second mounting portion 50. The second vertical wall portion 49 is formed into a plate standing upright from the support member base portion 41. The second vertical wall portion 49 may extend from one end to the other end of the eaves-side edge of the support member base portion 41. At the corner portion of the second vertical wall portion 49 and the support member base portion 41, a water drain hole 56 may be formed in such a manner as to penetrate the corner portion.

The second mounting portion 50 is formed at the upper end of the second vertical wall portion 49, and part of the edge portion of the lower surface of the photovoltaic module 2 can be mounted on the second mounting portion 50. The second mounting portion 50 is formed into a rectangular plate extending toward the first support portion 42. The distal end portion 52 of the second mounting portion 50 is formed in an upwardly bent shape, forming a second protrusion 50a on the upper surface of the second mounting portion 50. The second protrusion 50a may be formed to have a sharp tip so that when a photovoltaic module 2 is mounted thereon, the second protrusion 50a breaks through the protection layer on the surface of the frame 11 and comes into contact with the base part.

The pressing member 23 is mounted on the support member base portion 41 of the support member 22 with the biasing portion 44 interposed, as illustrated in FIGS. 2, 3, and 8. The pressing member 23 is configured to regulate the movement of the photovoltaic module 2. The pressing member 23 may include a base portion 60 and a regulating portion 61, and may be formed of iron, aluminum, or stainless steel.

The base portion 60 may constitute the lower end of the pressing member 23, and is arranged on the biasing portion 44. The base portion 60 may be formed into a rectangular plate elongated in the width direction of the base member 20. The length of the base portion 60 in the longitudinal direction may be determined to have the same dimension as that of the support member base portion 41 in the longitudinal direction. The length of the base portion 60 in the lateral direction is determined to be shorter than that of the support member base portion 41 in the lateral direction. The base portion 60 is provided with a hole 60a, through which the screw portion 24c of the bolt 24 can be inserted and through which the head portion 24a cannot be inserted. The hole 60a is larger than the diameter of the screw portion 24c and has a size sufficient for the regulating portion 61 to be moved between the first state P1 and the second state P2, which will be described later, with the screw portion 24c arranged.

The regulating portion 61 is provided on the base portion 60 and is configured to regulate the movement of the photovoltaic module 2. The regulating portion 61 may include a first regulating portion 62 and a second regulating portion 63.

The first regulating portion 62 is formed into a shape that stands upward from the eaves side of the upper surface of the base portion 60, for example, from the eaves-side edge thereof. The first regulating portion 62 may be formed into a rectangular plate. The ridge-side surface of the first regulating portion 62 comes into contact with the eaves-side side surface portion 14 of the ridge-side photovoltaic module 2, thereby regulating the movement of the photovoltaic module 2 toward the eaves side. On the ridge-side surface of the first regulating portion 62, a third mounting portion 62a is provided, on which part of the edge portion of the lower surface of the 20 ridge-side photovoltaic module 2 is arranged. The third mounting portion 62a is formed into a plate.

The eaves-side surface of the first regulating portion 62 comes into contact with the ridge-side side surface portion 14 of the eaves-side photovoltaic module 2, thereby regulating the movement of the photovoltaic module 2 toward the ridge side. A recess 64 is formed on the eaves-side surface of the first regulating portion 62 in such a manner that the distal end portion 52 of the second mounting portion 50 can be arranged in the recess 64. The depth of the recess 64 is determined to be approximately the same dimension as the thickness of the distal end portion 52.

The first regulating portion 62 may come into contact with the side surface portion 14 of the photovoltaic module 2 with the photovoltaic module 2 attached to the base member 20. Alternatively, the first regulating portion 62 may have a clearance between the first regulating portion 62 and the side surface portion 14, and if the photovoltaic module 2 moves toward the eaves side or the ridge side by a predetermined distance, the first regulating portion 62 may come into contact with the side surface portion 14, thereby regulating the movement of the photovoltaic module 2.

The second regulating portion 63 may be formed at the upper end of the first regulating portion 62. The second regulating portion 63 comes into contact with the upper surface portion 13 of the frame 11, which is an exemplary main surface of the photovoltaic module 2 opposite to the base member 20, thereby regulating the movement of the photovoltaic module 2 in a direction away from the base member 20. The second regulating portion 63 includes, for example, a third regulating portion 65 and a fourth regulating portion 66.

The third regulating portion 65 is formed into a plate extending to the ridge side. The third regulating portion 65 faces the third mounting portion 62a. As indicated by the double-dashed chain line in FIG. 2, the distance between the third regulating portion 65 and the third mounting portion 62a is determined to be larger than the thickness of the edge portion of a photovoltaic module 2 such that the photovoltaic module 2 held in an oblique posture can be inserted between the third regulating portion 65 and the third mounting portion 62a. Here, the oblique posture indicates a posture in which the longitudinal direction of the photovoltaic module 2 is tilted with respect to the extending direction of the third regulating portion 65 and the third mounting portion 62a, with the ridge-side end of the photovoltaic module 2 positioned above the eaves-side end thereof. The third regulating portion 65 may come into contact with the upper surface portion 13 of the photovoltaic module 2 with the photovoltaic module 2 engaged with the fastening tool 6, or may come into contact with the photovoltaic module 2 when the photovoltaic module 2 is moved upward by a predetermined distance, thereby regulating the movement of the photovoltaic module 2.

The fourth regulating portion 66 is formed into a plate extending to the eaves side. The fourth regulating portion 66 faces the second mounting portion 50 when the regulating portion 61 is in the first state P1. The distance between the fourth regulating portion 66 and the second mounting portion 50 when the regulating portion 61 is in the first state P1 is determined to be equal to the thickness of the edge portion of the photovoltaic module 2, or to be larger than the thickness of the edge portion of the photovoltaic module 2 to an extent that the photovoltaic module 2 can be inserted between the fourth regulating portion 66 and the second mounting portion 50 by moving it in a direction parallel to the upper surface of the photovoltaic module 2. The fourth regulating portion 66 may come into contact with the upper surface portion 13 of the photovoltaic module 2 with the photovoltaic module 2 engaged with the fastening tool 6, or may come into contact with the photovoltaic module 2 when the photovoltaic module 2 is moved upward by a predetermined distance, thereby regulating the movement of the photovoltaic module 2.

The biasing portion 44 may be formed integrally with the support member base portion 41. The pressing member 23 is mounted on the biasing portion 44. The biasing portion 44 is pressed via the pressing member 23 by the bolt 24 and the nut 25 that are mutually engaged and is thereby deformed, as a result of which the regulating portion 61 is displaced into the first state P1. The first state P1 is a state in which the regulating portion 61 can regulate the movement of the photovoltaic module 2. In the present embodiment, the first state P1 is a state in which the first regulating portion 62 may come into contact with the side surface portion 14 of the frame 11 of the photovoltaic module 2, and the second regulating portion 63 may come into contact with the upper surface portion 13 of the frame 11.

In addition, in the non-fastened state in which the nut 25 and the bolt 24 are not mutually engaged, the biasing portion 44 brings the regulating portion 61 of the pressing member 23 into the second state P2 as illustrated in FIG. 8, which differs from the first state P1. In the second state P2, the posture is tilting to the ridge side in comparison with the first state P1. In the second state P2, a larger clearance is created between the fourth regulating portion 66 and the upper surface portion 13 of the photovoltaic module 2 than in the first state P1.

The biasing portion 44 may be formed at the edge of each of the pair of holes 46 on the first support portion 42 side of the support member base portion 41. The biasing portion 44 may be formed to be a plate that extends upward, for example toward the second support portion 43 side. As shown in FIG. 8, the biasing portion 44 may extend from one end of the lower surface of the base portion 60 of the pressing member 23 on the first support portion 42 side to a middle portion on the other end side.

The biasing portion 44 is configured so as to be pivotable around an edge of the hole 46 under a pressure from above, up to a position where the upper surface 44a of the biasing portion 44 becomes flush with the upper surface of the support member base portion 41. The biasing portion 44 is formed to have a suitable size to fit in the hole 46. The thickness of the biasing portion 44 is determined to be a dimension equal to or smaller than the thickness of the support member base portion 41. When the biasing portion 44 is moved from the initial position, i.e., from the position in the unpressurized state, the biasing portion 44 exerts a restorative force, trying to return to the initial position. This restorative force is, for example, a force that returns the regulating portion 61 from the first state P1 to the second state P2 by loosening the nut 25 that has been engaged with the bolt 24.

The biasing portion 44, when being pressed downward and deformed, brings the pressing member 23 into a posture as illustrated in FIG. 2, in which the third regulating portion 65 regulates the movement of the photovoltaic module 2 on the ridge side and the fourth regulating portion 66 regulates the movement of the photovoltaic module 2 on the eaves side. That is, the third regulating portion 65 and the fourth regulating portion 66 are in the first state P1, in which they come into contact with part of the upper surface of the photovoltaic module 2.

At the initial position, or in other words, in the state of being downwardly unpressurized, the biasing portion 44 tilts the pressing member 23 toward the ridge side, as illustrated in FIG. 8. That is, the third regulating portion 65 and the fourth regulating portion 66 are in the second state P2, being tilted toward the first support portion 42, in comparison with the first state P1.

The bolt 24 and the nut 25 are adopted as an example of a fastening member that fasten the support member 22 and the pressing member 23 to the base member 20. This fastening member may include a shaft portion. The screw portion 24c of the bolt 24 is an example of a shaft portion of the fastening member. The bolt 24 and the nut 25 are engaged with each other, with the base member 20, the support member 22, and the pressing member 23 interposed, thereby fastening the support member 22 and the pressing member 23 to the base member 20. Furthermore, the mutually engaged bolt 24 and nut 25 press the pressing member 23 downward to deform the biasing portion 44 and change the posture of the pressing member 23, thereby changing the regulating portion 61 from the second state P2 to the first state P1.

The bolt 24 has a contact portion that comes into contact with the regulating portion 36 so as to regulate the rotation of the bolt 24. The contact portion may be provided between the head portion 24a and the screw portion 24c of the bolt 24. The bolt 24 may be a square-root round-head bolt including a head portion 24a, a base portion 24b, and a screw portion 24c, where the base portion 24b is an example of a contact portion. The base portion 24b may be formed into a polygonal shape, such as a rectangular shape. The screw portion 24c of the bolt 24 may be inserted into the groove 35 of the base member 20, the hole 45 of the support member 22, and the hole 60a of the pressing member 23 in a posture of the head portion 24a arranged beneath the base portion 30 of the base member 20. The nut 25 may be screwed into a portion of the screw portion 24c above the base portion 60. The nut 25 is engaged with the bolt 24 with the support member base portion 41 of the support member 22 and the base portion 60 of the pressing member 23 interposed.

The eaves-side fastening device 4 fastens the photovoltaic module 2 arranged farthest away on the eaves side, as shown in FIG. 2. The eaves-side fastening device 4 is an example of a fastening device that fastens a photovoltaic module 2. The eaves-side fastening device 4 may include a base member 20, a fastening member 21, a support member 22, an eaves-side pressing member 70, a bolt 24, and a nut 25.

The eaves-side pressing member 70 differs from the pressing member 23 in that the eaves-side pressing member 70 lacks the fourth regulating portion 66 and is provided with an engaging portion 72 for engagement of the decorative panel 5. That is, the eaves-side pressing member 70 includes the base portion 60, the first regulating portion 62, the third regulating portion 65, and the engaging portion 72. The engaging portion 72 is engaged with the decorative panel 5. The engaging portion 72 may be formed on the eaves-side surface of the first regulating portion 62.

As shown in FIG. 2, the decorative panel 5 covers the eaves side of the eaves-side pressing member 70 and the support member 22 of the eaves-side fastening device 4. The decorative panel 5 includes a main body 5a and an engaged portion 5b. The main body 5a is formed into a plate. The engaged portion 5b is engaged with the engaging portion 72 of the eaves-side pressing member 70.

Next, an operation of fastening the photovoltaic modules 2 to the roof 200 using the fastening device 3 and the eaves-side fastening device 4 will be described by adopting as an example a case of fastening a photovoltaic module 2 positioned farthest on the eaves side and a photovoltaic module 2 positioned on the ridge side of the farthest photovoltaic module 2. In the following description, the photovoltaic module 2 farthest on the eaves side will be referred to as a first photovoltaic module 2A, and the photovoltaic module 2 on the ridge side will be referred to as a second photovoltaic module 2B.

First, the worker arranges the fastening devices 3 that are tentatively fastened and the eaves-side fastening devices 4 that are tentatively fastened at the fastening positions on the roof 200. In the tentatively fastened state, the nut 25 is not engaged with the bolt 24, with the regulating portion 61 in the second state P2. The support member 22 and the pressing member 23 in the tentatively fastened state are movable along the groove 35. The worker places the base member 20 in such a manner that the marking 26a is disposed on the eaves side and the groove 35 extends in parallel to the third direction V3 and fastens the base member 20 to the roof 200 with the fastening member 21.

Next, the worker engages the engaged portion 5b with the engaging portion 72 to fasten the decorative panel 5 to the eaves-side pressing member 70 of the eaves-side fastening device 4. Next, the worker mutually engages the bolt 24 and the nut 25 to fasten the support member 22 and the eaves-side pressing member 70 to the base member 20. With the bolt 24 and the nut 25 mutually engaged, the biasing portion 44 is pressed downward and deformed by the base portion 60 of the eaves-side pressing member 70, bringing the third regulating portion 65 of the eaves-side pressing member 70 into the first state P1.

Next, the worker checks to see that the bolt 24 and the nut 25 of the eaves-side fastening device 4 are engaged. With the bolt 24 and the nut 25 engaged, the regulating portion 61 is in the first state P1. With the bolt 24 and the nut 25 unengaged, the regulating portion 61 is in the second state P2. If the regulating portion 61 is in the first state P1, the worker recognizes that the bolt 24 and the nut 25 are engaged. If the regulating portion 61 is in the second state P2, the worker tightens the nut 25 so as to engage the bolt 24 with the nut 25.

Thereafter, the operator inserts the end portion of the first photovoltaic module 2A between the third regulating portion 65 and the third mounting portion 62a by tilting the first photovoltaic module 2A, as shown in FIG. 2. Then, the worker lowers the ridge-side end portion of the first photovoltaic module 2A and places the first photovoltaic module 2A on the first mounting portion 48 and the third mounting portion 62a. When the first photovoltaic module 2A is mounted on the first mounting portion 48 and the third mounting portion 62a, the first protrusion 48a breaks the plating layer of the frame 11 so as to come into contact with the base part. Thus, the base part of the frame 11 and the support member 22 become electrically conductive.

Next, the worker places the ridge-side end portion of the lower surface of the first photovoltaic module 2A on the second mounting portion 50 of the support member 22 of the fastening device 3, which is fastened to the ridge side of the first photovoltaic module 2A. The worker adjusts the positions of the support member 22 and the pressing member 23 by moving the support member 22 and the pressing member 23 along the groove 35. When the first photovoltaic module 2A is mounted on the second mounting portion 50, the second protrusion 50a breaks the protection layer of the frame 11 so as to come into contact with the base part. Thus, the base part of the frame 11 and the support member 22 become electrically conductive.

Next, the worker engages the bolt 24 with the nut 25 of the fastening device 3 to fasten the support member 22 and the pressing member 23 to the base member 20. With the bolt 24 and the nut 25 engaged, the third regulating portion 65 and the fourth regulating portion 66 change from the second state P2 to the first state P1. In a similar manner to the case of the eaves-side fastening device 4, the worker checks to see that the bolt 24 and the nut 25 are engaged. If the bolt 24 and the nut 25 are unengaged, the third regulating portion 65 and the fourth regulating portion 66 are in the second state P2, as shown in FIG. 8.

Thereafter, the operator inserts the second photovoltaic module 2B between the third regulating portion 65 and the third mounting portion 62a with a tilted posture in a similar manner to the first photovoltaic module 2A. Then, the worker lowers the ridge-side end portion of the second photovoltaic module 2B and places the second photovoltaic module 2B on the first mounting portion 48 and the third mounting portion 62a. With the second photovoltaic module 2B mounted on the first mounting portion 48 and the third mounting portion 62a, the first protrusion 48a breaks the protection layer of the frame 11 to come into contact with the base part. Thus, the base part of the frame 11 and the support member 22 become electrically conductive.

Then, in the same manner as the above fastening operation of the ridge-side end portion of the first photovoltaic module 2A by the fastening device 3, the worker fastens the ridge-side end portion of the second photovoltaic module 2B by a fastening device 3, which is fastened on the ridge side. In this manner, the fastening operation of the first photovoltaic module 2A and the second photovoltaic module 2B using the fastening devices 3 and the eaves-side fastening device 4 is completed.

The worker repeats the same steps for the third and subsequent photovoltaic modules 2 from the eaves side in order to fasten the photovoltaic modules 2 to the roof 200. The photovoltaic modules 2 aligned in a row in the third direction V3 become electrically conductive via the support members 22 of the fastening devices 3 and the frames 11. For example, the worker may attach a ground wire to the support member 22 of the fastening device 3 farthest away on the ridge side to ground all the photovoltaic modules 2 arranged in a row from the eaves side to the ridge side. The fastening operation of the photovoltaic modules 2 to the roof 200 using the fastening devices 3 and the eaves-side fastening devices 4 is thereby completed.

Next, an example of replacement of a bolt 24 while keeping the base member 20 fastened to the roof 200 will be described. When replacing the bolt 24, the worker first removes the nut 25 and the pressing member 23 from the screw portion 24c. Then, the worker moves the head portion 24a to the first portion 37. By lifting the head portion 24a through the first portion 37, the worker removes the bolt 24 from the base member 20. Next, the worker attaches another bolt 24 to the base member 20 by lowering the head portion 24a of this bolt 24 through the first portion 37. In this manner, the replacement of the bolt 24 is completed.

In the fastening device 3 configured as described above, the regulating portion 61 is in the second state P2 if the bolt 24 and the nut 25 are not engaged, with the pressing member 23 tilted by the biasing portion 44. By visually checking to see that the regulating portion 61 is in the second state P2, the worker recognizes that the bolt 24 and the nut 25 are unengaged. This can improve the efficiency of checking by the worker to see whether the bolt 24 and the nut 25 are left unengaged, or in other words, whether the fastening tool 6 is left unfastened.

The biasing portion 44 has a restorative force, with which, if the regulating portion 61 is in the first state P1, the nut 25 is biased via the base portion 60. This can prevent the nut 25 from being loosened.

The fastening device 3 further fastens the support member 22, together with the pressing member 23, to the base member 20 by the bolt 24 and the nut 25. This prevents the support member 22 and the pressing member 23 from being displaced, as a result of which the efficiency of the fastening operation of the photovoltaic module 2 can be improved.

Furthermore, in the fastening device 3, the base member 20 is provided between two photovoltaic modules 2, the first regulating portion 62 is configured in such a manner as to come into contact with the side surface portions 14 of the photovoltaic modules 2 on the ridge side and the eaves side, and the second regulating portion 63 is configured in such a manner as to come into contact with the upper surface portions 13 of the photovoltaic modules 2 on the ridge side and the eaves side. Thus, the movement of two photovoltaic modules 2 can be regulated by one fastening device 3.

The upper surface 26 of the base member 20 is formed into a flat surface parallel to the roof board 202 in a state where the base member 20 is fastened to the roofing member 201. Thus, the photovoltaic module 2 can be fastened in parallel with the roof board 202.

Furthermore, the base member 20 allows the tentatively fastened support member 22 and pressing member 23 to move along the groove 35, and therefore the positions of the support member 22 and the pressing member 23 can be adjusted during the operation of fastening the photovoltaic modules 2. Without the need to remove the base member 20 during the adjustment of the positions of the support member 22 and the pressing member 23, the efficiency in the operation of fastening the photovoltaic modules 2 can be improved.

Moreover, the base member 20 is configured such that its upper surface 26 becomes parallel to the roof board 202 owing to the vertical length of the vertical wall portion 34. This simplifies the configuration of the base member 20. The base member 20 further includes a marking 26a. This can enhance the efficiency of the operation of fastening the base member 20.

The groove 35 includes the first portion 37 through which the head portion 24a can be inserted. The bolt 24 therefore can be replaced without detaching the base member 20 from the roof 200. The base member 20 also includes a regulating portion 36 that regulates the rotation of the bolt 24. This can improve the efficiency in fastening the bolt 24 and the nut 25. Furthermore, the regulating portion 36 includes a pair of vertical wall portions 36a formed at the opposing edges of the groove 35. This can simplify the configuration of the regulating portion 36.

The support member 22 is arranged below two photovoltaic modules 2. This means that the support member 22 is less exposed to ultraviolet radiation, which allows a resin material to be used for preparation of the support member 22.

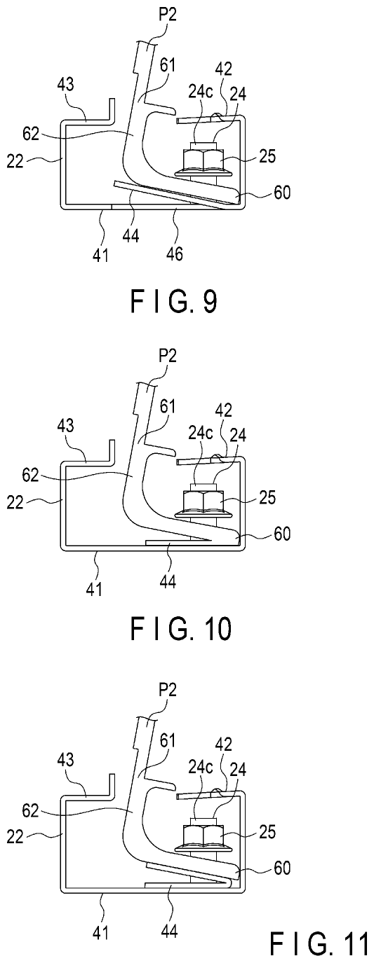

In the above-described example, the biasing portion 44 is formed into a shape that extends from one end of the lower surface of the base portion 60 of the pressing member 23 on the first support portion 42 side to a middle portion on the other end side, which is not a limitation. In another example, the biasing portion 44 is formed into a shape that extends from one end of the lower surface of the base portion 60 on the first support portion 42 side up to the other end or from one end beyond the other end, as shown in FIG. 9.

In the example described above, the configuration in which the biasing portion 44 is formed integrally with the support member base portion 41 has been described, which is not a limitation. In another example, the biasing portion 44 is a separate member from the support member 22 and is formed integrally with the pressing member 23, as shown in FIG. 10. In the example of FIG. 10, the biasing portion 44 is formed at one end of the base portion 60 on the first support portion 42 side. Alternatively, in another example, the biasing portion 44 may be provided separately from both the support member 22 and the pressing member 23, as shown in FIG. 11. In the example of FIG. 11, the biasing portion 44 is formed into a wedge shape by bending one plate member at one position. In the examples of FIGS. 10 and 11, the support member base portion 41 may not have a hole 46.

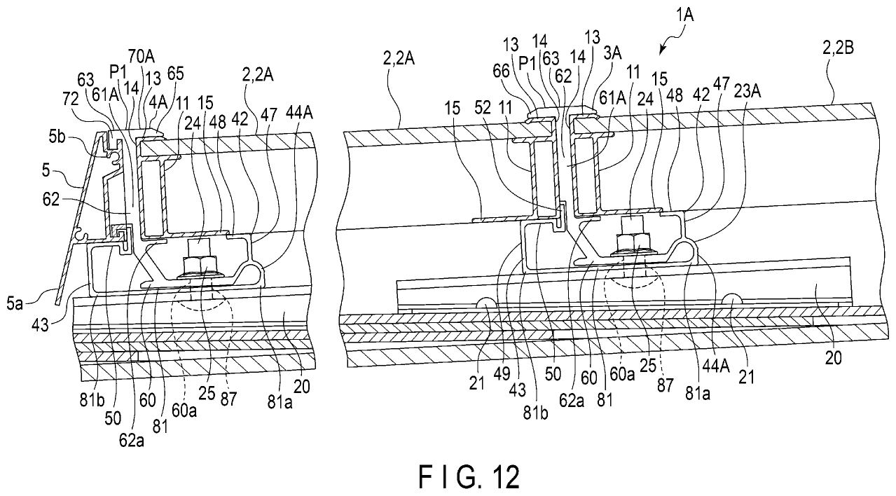

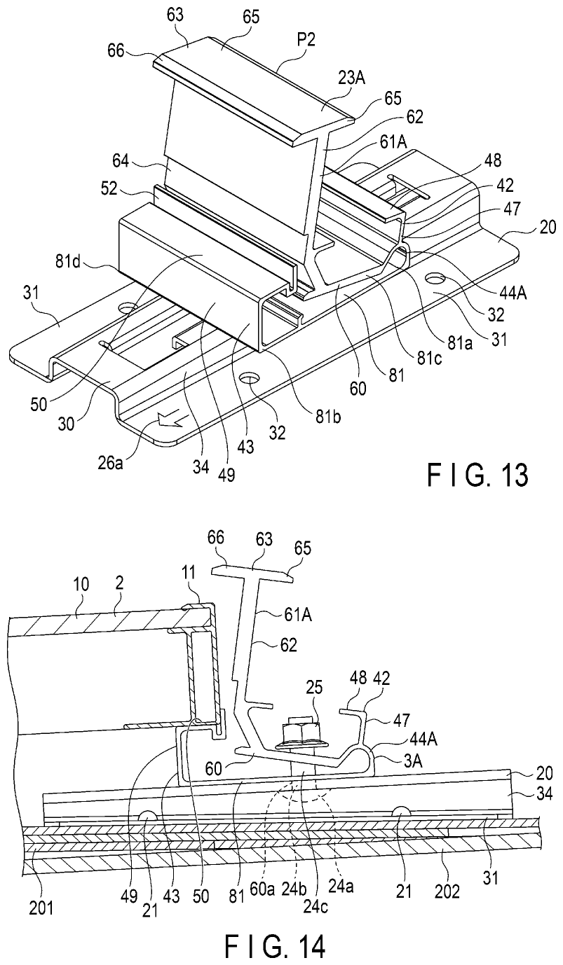

Next, a photovoltaic power generation system 1A according to a second embodiment of the present invention will be described with reference to FIGS. 12 to 14. Components having the same functions as those of the first embodiment will be denoted by the same reference numerals as those of the first embodiment, and the description will be omitted. FIG. 12 is a cross-sectional view showing the photovoltaic power generation system 1A, where the ridge side is the right side of the sheet, and the eaves side is the left side. FIG. 13 is a perspective view showing the fastening device 3A of the photovoltaic power generation system 1A. FIG. 14 is a cross-sectional view showing the fastening device 3A in a tentatively fastened state, where the ridge side is the right side of the sheet, and the eaves side is the left side.

The photovoltaic power generation system 1A is installed, for example, on the roof 200 of a house. As shown in FIG. 12, the photovoltaic power generation system 1A includes a plurality of photovoltaic modules 2, a plurality of fastening devices 3A, a plurality of eaves-side fastening devices 4A, and a plurality of decorative panels 5.

A fastening device 3A includes a base member 20, a fastening member 21, a pressing member 23A, and a bolt 24 and a nut 25 for fastening the pressing member 23A to the base member 20. In the present embodiment, the pressing member 23A is an example of a fastening tool. The pressing member 23A may include an interposed portion 81, a biasing portion 44A, a base portion 60, a regulating portion 61A, a first support portion 42, and a second support portion 43. The pressing member 23A may be formed of aluminum.

As shown in FIG. 12, the interposed portion 81 is arranged on the base member 20. The interposed portion 81 may be formed into a rectangular plate. The interposed portion 81 has a first edge 81a, a second edge 81b, a third edge 81c, and a fourth edge 81d. The interposed portion 81 is formed into a plate elongated in the width direction of the base member 20. The first edge 81a and the second edge 81b are edges that extend along the longitudinal direction. A hole 87 through which the screw portion 24c of the bolt 24 is arranged is formed in the interposed portion 81. The length of the interposed portion 81 in the longitudinal direction is determined to be greater than the width of the base portion 30 of the base member 20. The interposed portion 81 has a hole 87 through which the screw portion 24c can be arranged.

The biasing portion 44A is formed in the interposed portion 81. The biasing portion 44A may be formed on the first edge 81a. The biasing portion 44A may be formed into a folded shape by folding the interposed portion 81 back toward the second edge 81b side facing the first edge 81a. In the state of the bolt 24 and the nut 25 being mutually unengaged, the biasing portion 44A brings the regulating portion 61A into the second state P2. When the bolt 24 and the nut 25 are mutually engaged, the biasing portion 44A becomes deformed with its end approaching the interposed portion 81 in the pivoting movement and brings the regulating portion 61A into the first state P1. When the bolt 24 and the nut 25 are loosened from the engaged state, the biasing portion 44A exerts a restorative force that returns the regulating portion 61A from the first state P1 to the second state P2.

The biasing portion 44A may be formed into a curvature projecting in a direction away from the interposed portion 81. The width direction is defined as a direction from one of the two ends to the other end of the opening of the biasing portion 44A. The width direction is parallel to the first edge 81a of the interposed portion 81. The biasing portion 44A extends from one end to the other end of the first edge 81a. The cross section of the biasing portion 44A orthogonal to the width direction has a shape unchanged from one end to the other end in the width direction.

The base portion 60 is formed at one end of the biasing portion 44A in the pivoting direction. The base portion 60 at the end of the biasing portion 44A extends from one end to the other end with respect to the width direction.

The regulating portion 61A is provided on the base portion 60 and is capable of regulating the movement of the photovoltaic module 2. The regulating portion 61A includes a first regulating portion 62 and a second regulating portion 63. The first regulating portion 62 is arranged on the opposite side of the base portion 60 with respect to the biasing portion 44A. The first regulating portion 62 extends from one end to the other end of the base portion 60 in the width direction. The cross section of the first regulating portion 62 orthogonal to the width direction has a shape unchanged from one end to the other end in the width direction. The second regulating portion 63 is arranged at the upper end of the first regulating portion 62. The second regulating portion 63 extends from one end to the other end of the upper end of the first regulating portion 62 in the width direction. The cross section of the regulating portion 61A orthogonal to the width direction has a shape unchanged from one end to the other end in the width direction.

The first support portion 42 may be formed in the upper portion of the biasing portion 44A. The first support portion 42 extends from one end to the other end of the biasing portion 44A in the width direction. The first mounting portion 48 does not include, for example, the first protrusion 48a. The first mounting portion 48 may be formed as a flat surface parallel or substantially parallel to the upper surface of the interposed portion 81 in a state where the bolt 24 and the nut 25 are mutually engaged.

The second support portion 43 may be formed at one end of the interposed portion 81 on the eaves side. The second support portion 43 extends from one end to the other end of the interposed portion 81 in the width direction. The cross section of the second support portion 43 orthogonal to the width direction has an unchanged shape. The second mounting portion 50 does not include, for example, the second protrusion 50a. In the present embodiment, the interposed portion 81, the first support portion 42, and the second support portion 43 constitute a support member, which is included in the pressing member 23A.

The eaves-side fastening device 4A includes a base member 20, a fastening member 21, an eaves-side pressing member 70A, and a bolt 24 and a nut 25 for fastening the eaves-side pressing member 70A to the base member 20. The eaves-side pressing member 70A is an example of a fastening tool. The eaves-side pressing member 70A differs from the pressing member 23A of the fastening device 3A in that the eaves-side pressing member 70A lacks the fourth regulating portion 66 and is provided with an engaging portion 72.

In the present embodiment, with the bolt 24 and the nut 25 unengaged as shown in FIG. 14, the regulating portion 61 is in the second state P2, and therefore the same operation and effects as in the first embodiment can be obtained. The same operation and effects can be obtained by the eaves-side fastening device 4.

Furthermore, the fastening device 3A is configured without a support member 22, and therefore the number of components can be reduced. The cross section of the pressing member 23A orthogonal to the width direction has an unchanged shape, which means that the pressing member 23A can be prepared through extrusion molding. Furthermore, the pressing member 23A can be formed of aluminum, which means that the pressing member 23A is resistant to corrosion.

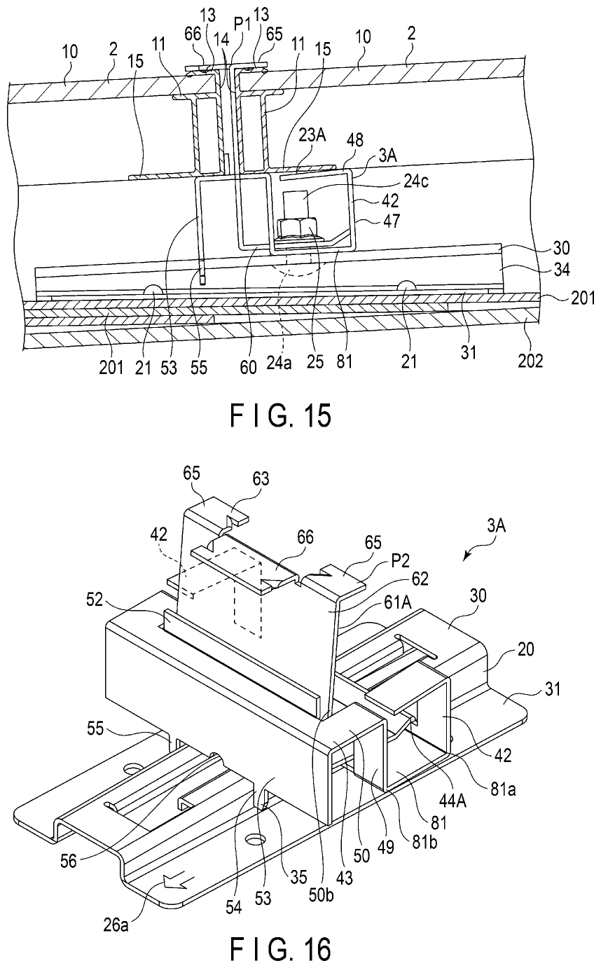

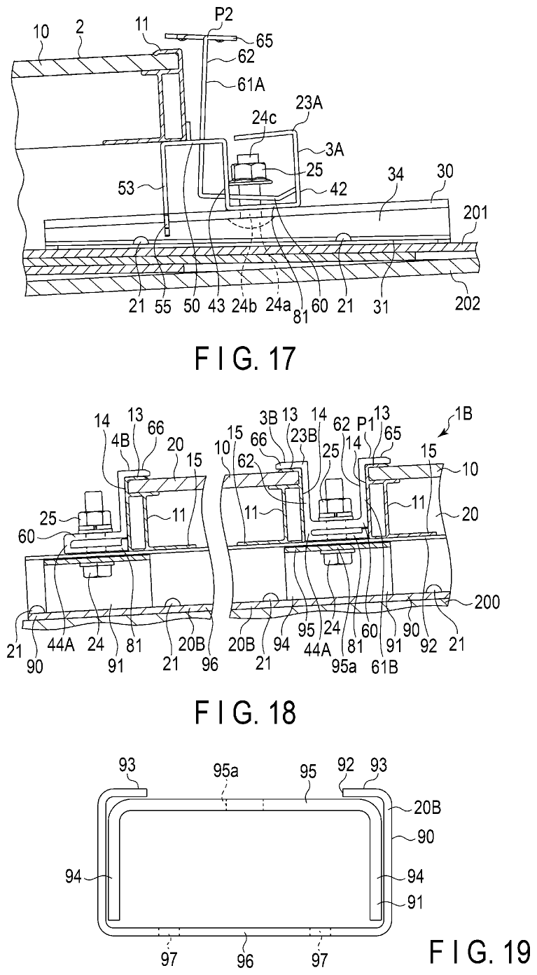

In the above-described example, the cross section of the pressing member 23A orthogonal to the width direction has been described as having a constant shape, which is not a limitation. Another example of the pressing member 23A will be described with reference to FIGS. 15 to 17. FIG. 15 is a cross-sectional view showing a photovoltaic power generation system 1A that includes a modification example of the fastening device 3A, where the ridge side is the right side of the sheet, and the eaves side is the left side. FIG. 16 is a perspective view showing a modification example of the fastening device 3A. FIG. 17 is a cross-sectional view showing the modification example of the fastening device 3A in a tentatively fastened state, where the ridge side is the right side of the sheet, and the eaves side is the left side.

As shown in FIGS. 15 to 17, the biasing portion 44A is formed in the center of the first edge 81a of the interposed portion 81, and the first support portions 42 are formed in the biasing portion 44A, on the two sides of the first edge 81a in the width direction. The fourth regulating portion 66 is formed in the center of the upper end of the first regulating portion 62 in the width direction. The third regulating portions 65 are formed at the upper end of the first regulating portion 62, on the two sides of the fourth regulating portion 66 in the width direction.

The second vertical wall portions 49 of the second support portion 43 are formed on the two sides of the second edge 81b of the interposed portion 81 in the width direction across the regulating portion 61A, and the second mounting portion 50 has, at its center in the width direction, a rectangular hole 50b in which the regulating portion 61 is arranged. A distal end portion 52 is formed at an edge of the hole 50b facing the regulating portion 61A. A third vertical wall portion 53 is formed to extend downward at an edge of the second mounting portion 50 on a side opposite to the second vertical wall portion 49. The regulating portion 54 is formed on the third vertical wall portion 53 in such a manner as to be capable of regulating the pivoting movement of the pressing member 23A with respect to the base member 20. The regulating portion 54 includes a pair of protruding portions 55, which are formed in the center of the lower end of the third vertical wall portion 53 in the width direction, with the base portion 30 and the pair of vertical wall portions 34 of the base member 20 interposed. The distance between the protruding portions 55 is determined to be a distance at which the pivoting movement of the pressing member 23A can be regulated by bringing the pressing member 23A into contact with the outer surfaces of the vertical wall portions 34.

The pressing member 23A configured as described above may be formed of stainless steel or steel. The pressing member 23A configured as described above can be prepared, for example, by bending a single plate member having a shape corresponding to the interposed portion 81, the biasing portion 44A, the regulating portion 61A, the first support portion 42, and the second support portion 43.

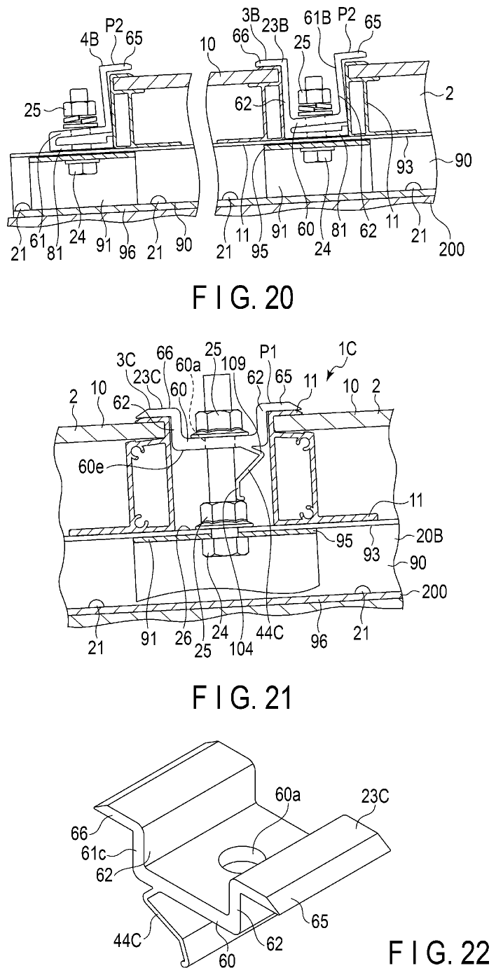

Next, a photovoltaic power generation system 1B according to the third embodiment of the present invention will be described with reference to FIGS. 18 to 20. The components having the same functions as those of the second embodiment will be denoted by the same reference numerals as those of the second embodiment, and the description will be omitted. FIG. 18 is a cross-sectional view showing the photovoltaic power generation system 1B, where the ridge side is the right side of the sheet and the eaves side is the left side. FIG. 19 is a front view showing the base member 20B. FIG. 20 is a cross-sectional view showing the fastening device 3B and the eaves-side fastening device 4A in a tentatively fastened state. The photovoltaic power generation system 1B is installed, for example, on a roof 200. In FIG. 20, the ridge side is the right side of the sheet and the eaves side is the left side. As shown in FIG. 18, the photovoltaic power generation system 1B includes a plurality of photovoltaic modules 2, a plurality of fastening devices 3B, and a plurality of eaves-side fastening devices 4B.

A fastening device 3B includes a base member 20B, a fastening member 21 for fastening the base member 20B to the roof 200, a pressing member 23B, a bolt 24, and a nut 25. The base member 20B may include a main body 90 and a bolt support portion 91. The photovoltaic module 2 is mounted on the upper surface of the base member 20B. In the present embodiment, the roof 200 is not provided, for example, with roofing members 201, and the upper surface of the roof 200 is configured into a flat surface.

As shown in FIGS. 18 and 19, the main body 90 is formed, for example, into a rectangular tubular shape elongated in one direction, and a groove 92 is formed in an upper wall 93 so as to extend from one end to the other end in the longitudinal direction. The main body 90 constitutes a support member that supports the photovoltaic module 2 by mounting the photovoltaic module 2 on the upper wall 93. The groove 92 passes through the upper wall 93. The width of the groove 92 is determined to be a dimension that allows the screw portion 24c of the bolt 24 to be movable in the longitudinal direction of the groove 92. An insertion hole 97 is formed, for example, in the bottom wall portion 96 of the main body 90, through which the fastening member 21 is inserted. One main body 90 may be provided with one or more insertion holes 97.

The bolt support portion 91 supports the head portion 24a with the screw portion 24c facing upward. In the present embodiment, the bolt 24 may not have a base portion 24b. The bolt support portion 91 is arranged in the main body 90 so as to be movable in the longitudinal direction of the main body 90. The bolt support portion 91 may include a pair of side wall portions 94 and an upper wall portion 95. The dimensions of the side wall portions 94 and the upper wall portion 95 are determined such that the bolt support portion 91 can movably fit in the main body 90. A hole 95a is formed in the upper wall portion 95, through which the screw portion 24c is inserted.

In the present embodiment, the pressing member 23B is an example of a fastening member. As illustrated in FIG. 18, the pressing member 23B may include an interposed portion 81, a biasing portion 44A, a base portion 60, and a regulating portion 61B. The regulating portion 61B may include a base portion 60, a pair of first regulating portions 62, a third regulating portion 65, and a fourth regulating portion 66.

In the present embodiment, the biasing portion 44A is arranged at one end of the interposed portion 81 on the eaves side and at one end of the base portion 60 on the eaves side.

One of the first regulating portions 62 is formed on the eaves side of the base portion 60 or on the biasing portion 44. This first regulating portion 62 may be formed on the biasing portion 44. The first regulating portion 62 may be formed such that the side surface portion 14 of the eaves-side photovoltaic module 2 can be brought into contact therewith. The other first regulating portion 62 is formed on the ridge side of the base portion 60. In the present embodiment, the other first regulating portion 62 is formed at the ridge-side edge of the base portion 60. This first regulating portion 62 is configured such that the side surface portion 14 of the ridge-side photovoltaic module 2 can be brought into contact therewith.

The third regulating portion 65 may be formed at the upper end of one of the first regulating portions 62. The fourth regulating portion 66 may be formed at the upper end of the other first regulating portion 62.

The eaves-side fastening device 4B differs from the fastening device 3B in that the eaves-side fastening device 4B does not include the other first regulating portion 62 and the fourth regulating portion 66.

If the bolt 24 and the nut 25 are not mutually engaged, the fastening device 3B and the eaves-side fastening device 4B configured as described above are in the second state P2 with the aforementioned other first regulating portion 62 and the third regulating portion 65 being separated from the photovoltaic module 2, as shown in FIG. 20. The fastening device 3B and the eaves-side fastening device 4B as described above can achieve the same operation and effects as those of the second embodiment. At least two of, or for example all of, the main bodies 90 of the base members 20B in the eaves-side fastening device 4B and all of the fastening devices 3B that are aligned in the third direction V3 may be integrally formed.

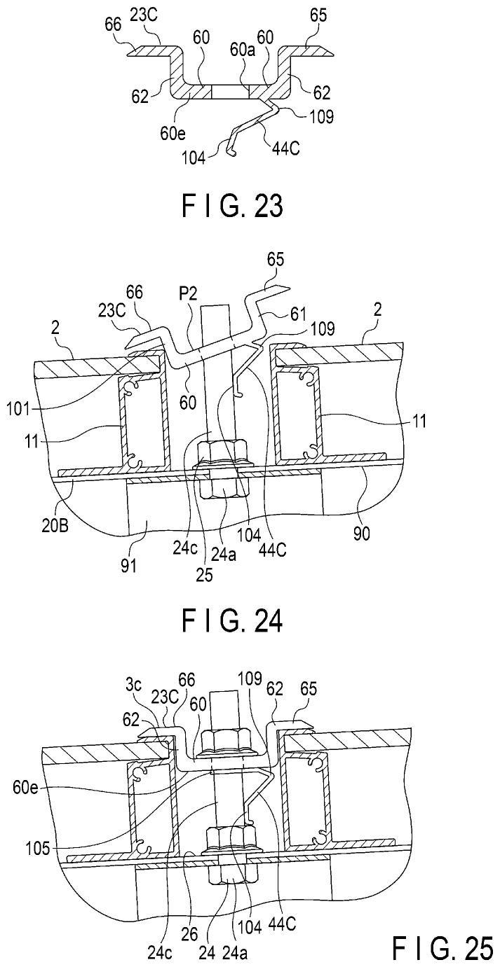

Next, a photovoltaic power generation system 1C according to the fourth embodiment of the present invention will be described with reference to FIGS. 21 to 25. The components having the same functions as those of the third embodiment will be denoted by the same reference numerals as those of the third embodiment, and the description thereof will be omitted. FIG. 21 is a cross-sectional view showing the photovoltaic power generation system 1C, where the ridge side is the right side of the sheet, and the eaves side is the left side. FIG. 22 is a perspective view showing the pressing member 23C, and FIG. 23 is a cross-sectional view showing the pressing member 23C. FIG. 24 is a cross-sectional view showing the fastening device 3C in a tentatively fastened state, where the ridge side is the right side of the sheet and the eaves side is the left side.

The photovoltaic power generation system 1C is installed, for example, on the roof 200. The photovoltaic power generation system 1C includes a plurality of photovoltaic modules 2 and a plurality of fastening devices 3C. The plurality of photovoltaic modules 2 are fastened to the roof 200 by the fastening devices 3C. As shown in FIGS. 21 to 24, the fastening device 3C includes a base member 20B, a fastening member 21, a pressing member 23C, a bolt 24, and a pair of nuts 25.

In the present embodiment, the pressing member 23C is an example of a fastening tool. The pressing member 23C includes a base portion 60, a pair of first regulating portions 62, a third regulating portion 65, a fourth regulating portion 66, and a biasing portion 44C. The dimensions of the first regulating portion 62 are determined such that a clearance is created between the lower surface 60e of the base portion 60 and the upper surface of the base member 20B when the third regulating portion 65 and the fourth regulating portion 66 are in the first state P1. The first regulating portions 62 extend, for example, from one end to the other end of the base portion 60 in the width direction of the base member 20B. The third regulating portion 65 and the fourth regulating portion 66 extend, for example, from one end to the other end of the base portion 60 in the width direction of the base member 20B.

The biasing portion 44C is formed on the lower surface 60e of the base portion 60. The biasing portion 44C is formed in a shape extending downward from the lower surface 60e. One end of the biasing portion 44C may be formed at the edge of the hole 60a on the ridge-side first regulating portion 62 side or on the eaves-side first regulating portion 62 side. In the present embodiment, one end of the biasing portion 44C is formed at the edge of the hole 60a on the ridge-side first regulating portion 62 side. Furthermore, the biasing portion 44C extends, for example, from one end to the other end of the base portion 60 in the width direction of the base member 20B.

The biasing portion 44C has an abutment portion 104 on its distal end side. If the pressing member 23C is not attached to the screw portion 24c as illustrated in FIG. 23, the abutment portion 104 may be located at a position facing the hole 60a in the axial direction of the hole 60a. With the pressing member 23C attached to the screw portion 24c, the abutment portion 104 comes into contact with the screw portion 24c.

One of the nuts 25 is engaged with the bolt 24, with the bolt support portion 91 interposed. The other nut 25 is engaged with the bolt 24, with the base portion 60 interposed.

With the abutment portion 104 abutting on the screw portion 24c, the biasing portion 44C presses the pressing member 23C via the base portion 60. If the bolt 24 and the nut 25 are unengaged as illustrated in FIG. 24, the pressing member 23 is tilted by the biasing portion 44C, bringing the third regulating portion 65 and the fourth regulating portion 66 into the second state P2. With the other nut 25 engaged with the bolt 24, the biasing portion 44C is pressed and deformed by the base portion 60 pressing the biasing portion 44C, thereby bringing the third regulating portion 65 and the fourth regulating portion 66 into the first state P1.

The biasing portion 44C has a bent portion 109, for example, between its one end on the lower surface 60e side and the abutment portion 104. The bent portion 109 is formed into a shape that opens outwardly on the screw portion 24c side. With the pressing member 23C attached to the screw portion 24c, the abutment portion 104 abuts on the screw portion 24c. In comparison with the state prior to the attachment of the pressing member 23C, the bent portion 109 is more widely opened.

The fastening device 3C configured as described above has the same operation and effects as those of the second embodiment.

In the example described above, the biasing portion 44C has been described to be formed integrally with the base portion 60, which is not a limitation. In another example, the biasing portion 44C is prepared as a member separate from the base portion 60, as shown in FIG. 25. That is, the biasing portion 44C is a separate member from the pressing member 23C. In this modification example, one end portion 105 of the biasing portion 44C on the base portion 60 side is formed into an annular shape for arranging the screw portion 24c.

The present invention is not limited to the configurations of the above-described embodiments. For instance, in consideration of the fact that part of the edge portion of the lower surface of the photovoltaic module 2 is placed on the first mounting portion 48, the support member 22 described above may be configured to have a shape that can improve the strength of the support member 22. In the first embodiment described above, prior to the fastening of the base portion 60 to the base member 20 with the bolt 24 and the nut 25, the biasing portion 44 tilts the regulating portion 61 with respect to the posture of the regulating portion 61 regulating the movement of the photovoltaic module 2, and also is tilted in the same direction as the tilting direction of the regulating portion 61. This is not a limitation, however. The biasing portion 44 may be configured to tilt in a direction different from the tilting direction of the regulating portion 61.

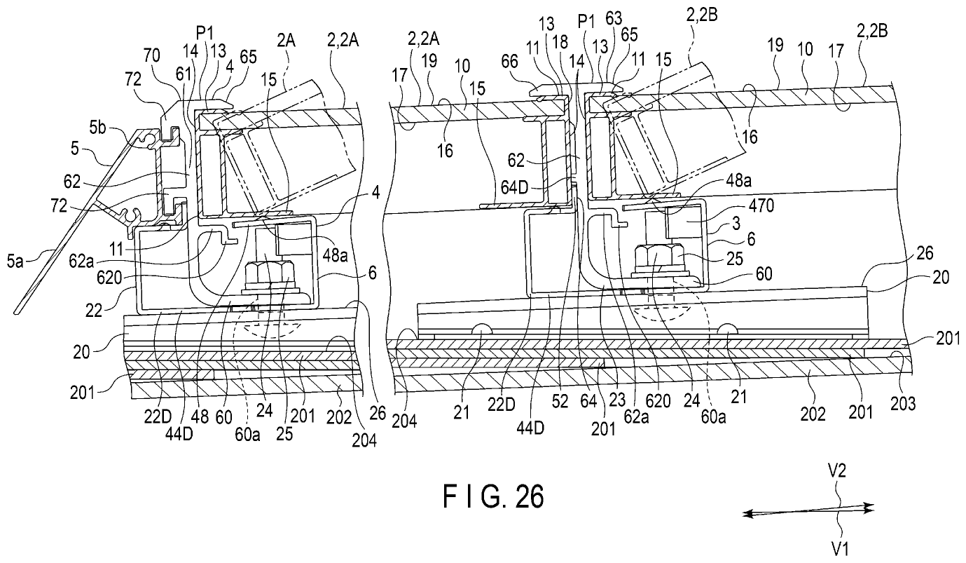

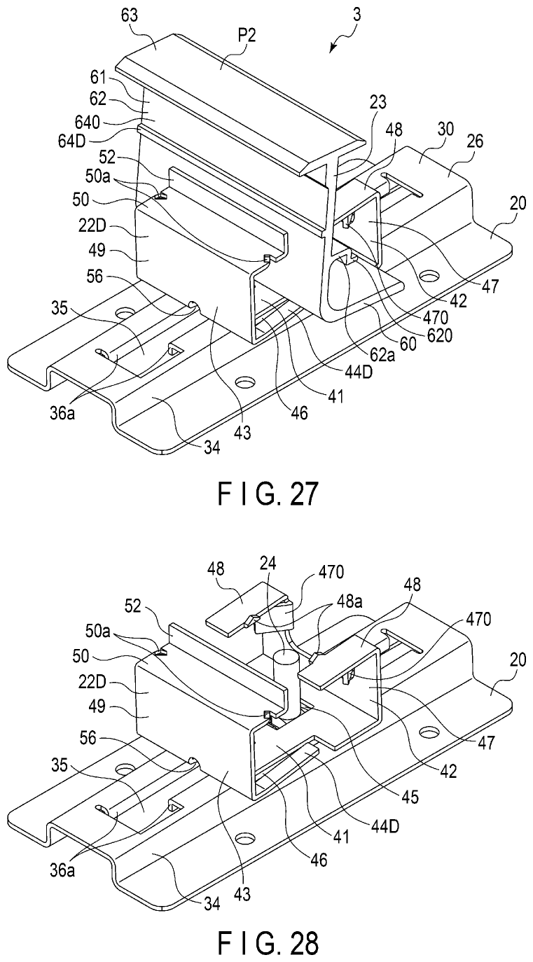

Next, the configuration of the support member 22D of the fastening device 3 in the photovoltaic power generation system 1 according to the fifth embodiment of the present invention is shown in FIGS. 26 to 30. The support member 22D according to the fifth embodiment differs from the support member 22 according to the first embodiment described above in the tilting direction of the biasing portion 44, the position of the first protrusion 48a of the first mounting portion 48, the bent portion 470 formed in the lower portion of the first mounting portion 48, and two holes 45 provided in the support member base portion 41.

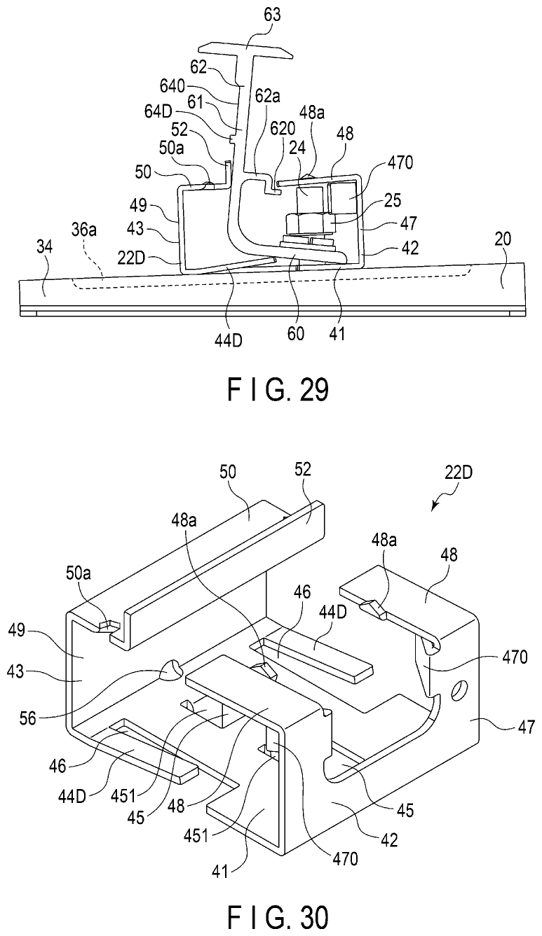

As illustrated in FIG. 29, the support member 22D of the fastening device 3 in the fifth embodiment is configured such that the biasing portion 44D and the base portion 60 of the pressing member 23 are tilted in different directions, and the upper end of the biasing portion 44D and the lower surface of the base portion 60 are in contact with each other. For instance, the support member base portion 41 includes a pair of biasing portions 44D and a bent portion 451.

The pair of biasing portions 44D may be respectively provided at the edge portions of the surface of the support member base portion 41 in the width direction orthogonal to the opposing direction of the first vertical wall portion 47 of the first support portion 42 and the second vertical wall portion 49 of the second support portion 43 in the support member base portion 41. The biasing portions 44D are provided within a range between the second vertical wall portion 49 side and the center of the support member base portion 41 in the opposing direction of the first vertical wall portion 47 and the second vertical wall portion 49.

The biasing portion 44D has a proximal end that is formed integrally with and continuous with the second vertical wall portion 49 side of the support member base portion 41. The biasing portion 44D extends from the proximal end to the distal end toward the first vertical wall portion 47 side and the first mounting portion 48 side. The biasing portion 44D is tilted toward the first mounting portion 48 side with respect to the support member base portion 41. In other words, the biasing portion 44D is tilted such that the eaves-side end portion (proximal end) of the biasing portion 44D is connected to the support member base portion 41 and the ridge-side end portion (distal end) of the biasing portion 44D is spaced apart from the base member 20.

In the biasing portion 44D, the distance between the distal end and the first vertical wall portion is larger than the distance between the proximal end and the second vertical wall portion 49. The biasing portion 44D tilts the pressing member 23 so as to bring the distal end into contact with the base portion 60 and achieve the second state P2.

The biasing portion 44D may be formed by creating a hole 46 or an incision in part of the support member base portion 41 and bending the portion incised from the support member base portion 41 toward the first mounting portion 48. That is, the hole 46 is provided in order to form the biasing portion 44D, and therefore is formed in a range between the second vertical wall portion 49 side and the center of the support member base portion 41 in the opposing direction of the first vertical wall portion 47 and the second vertical wall portion 49.

In the first vertical wall portion 47, an opening or cutout may be provided by forming each of its corner portions into a curved surface having a predetermined radius of curvature so as to improve strength. The first vertical wall portion 47 includes a pair of bent portions 470. The bent portions 470 are provided closer to the first mounting portion 48 than the corners of the opening or the cutout. Each of the bent portions 470 has a proximal end that is formed integrally with and continuous with the edge portion of the opening or cutout formed in the upper central portion of the first vertical wall portion 47. The bent portions 470 are formed by bending part of the first vertical wall portion 47 at its proximal end toward the inner surface side of the first vertical wall portion 47. That is, when forming an opening or cutout in the formation of the first vertical wall portion 47, an opening or cutout is cut while leaving small pieces, which will become bent portions 470. The bent portions 470 are formed by bending these small pieces. The bent portion 470 forms an acute angle with the first vertical wall portion 47. The bent portion 470 is partially positioned below the first mounting portion 48.

The first mounting portion 48 is provided with the first protrusion 48a, for example, at the central portion of the inner side surface of the first mounting portion 48.

The support member base portion 41 has two holes 45 and includes two bent portions 451 respectively arranged in the holes 45. A bent portion 451 is formed, for example, by leaving a rectangular small piece continuous with the second vertical wall portion 49 side to obtain the bent portion 451 in the formation of the hole 45 in the support member base portion 41, and bending this small piece toward the side opposite to the first mounting portion 48. That is, the two bent portions 451 are respectively provided at the edge portions of the two holes 45 on the second vertical wall portion 49 side.

When the support member 22D is mounted on the base member 20, the distal ends of the two bent portions 451 come into the groove 35 of the base member 20. The width of the bent portion 451 in the direction parallel to the second vertical wall portion 49 may be smaller than the width of the groove 35 in the lateral direction of the base member 20. The length from the proximal end to the distal end of the bent portion 451 may be equal to or greater than the length from the proximal end to the distal end of the vertical wall portions 36a and shorter than the minimum length from the upper end of the vertical wall portions 34 to the roof 200. At least one of the two bent portions 451 comes into contact with the vertical wall portions 36a, thereby regulating the movement of the support member 22D in the lateral direction of the base member 20 of the support member 22D and regulating the pivoting movement of the support member 22D around the rotation axis of the bolt.

Two holes 45 are provided side by side along the groove 35 of the base member 20 in the opposing direction of the first vertical wall portion 47 and the second vertical wall portion 49. One of the two holes 45 on the first vertical wall portion 47 side allows a bolt 24 to be inserted through, while the other one of the two holes 45 on the second vertical wall portion 49 side does not allow a bolt 24 to be inserted through. The two holes 45 may have different sizes.

In a manner similar to the support member 22 of the first embodiment, when the support member 22D is in the unfastened state in which the bolt 24 and the nut 25 are uninserted or in which the bolt 24 and the nut 25 are inserted but are only tentatively fastened, the distal end of the base portion 60 comes into contact with the support member base portion 41, and the biasing portion 44D lifts the regulating portion 61 so as to separate the first regulating portion 62 side of the base portion 60 from the support member base portion 41 toward the first mounting portion 48 side. In other words, in the unfastened state, the regulating portion 61 is tilted toward the ridge side and brought into the second state P2, producing the same effects as those of the first embodiment.

In addition to the above-described effects, the support member 22D of the present embodiment can improve the strength. This can be achieved because of the biasing portion 44D provided in the range between the second vertical wall portion 49 side and the center of the support member base portion 41. The support member 22D therefore can ensure that the area (width) of the support member base portion 41 on the first vertical wall portion 47 side is larger than the area (width) thereof on the second vertical wall portion 49 side. That is, in the present embodiment, the strength of the support member base portion 41 on the first vertical wall portion 47 side is improved in comparison with the support member base portion 41 of the first embodiment. In addition, the bent portion 470 provided in the lower portion of the first mounting portion 48 can support the first mounting portion 48 when the first mounting portion 48 is subjected to the load of the photovoltaic module 2 and is deformed toward the support member base portion 41 side. Thus, deformation of the first vertical wall portion 47 can be suppressed. In addition, with the bent portion 470 provided in the first vertical wall portion 47, the strength of the first vertical wall portion 47 can also be improved.

The third mounting portion 62a of the regulating portion 61 has been described above as having a plate shape, as illustrated in FIGS. 2, 3, and 8, which is not a limitation. The third mounting portion 62a may include a step portion 620 at its distal end, as shown in FIGS. 26, 27, and 29. The upper surface of the step portion 620 is located on the base portion 60 side with respect to the third mounting portion 62a. The step portion 620 is partially positioned below the end portion of the first mounting portion 48. When the first mounting portion 48 is deformed under a load applied thereto and bent toward the support member base portion 41 side, the distal end of the first mounting portion 48 will come into contact with the upper surface of the step portion 620. That is, the first mounting portion 48 can be supported by the step portion 620 in addition to the bent portion 470, and the deformation of the first mounting portion 48 and the first vertical wall portion 47 can be suppressed.

The first regulating portion 62 of the regulating portion 61 is described above as being formed into a rectangular plate and having a recess 64 for arranging the distal end portion 52 of the second mounting portion 50 therein in the eaves-side surface of the first regulating portion 62, as shown in FIGS. 2, 3, and 8. This is not a limitation, however. The first regulating portion 62 may be configured to have a dent 640 in the eaves-side surface of the first regulating portion 62, as shown in FIGS. 26, 27, and 29, so that a protrusion 64D can be formed between the recess 64 and the dent 640 and the side surface portion 14 of the photovoltaic module 2 can partially come into contact with this protrusion 64D.

The eaves-side fastening device 4 has been described as including one engaging portion 72 of the eaves-side pressing member 70 as shown in FIG. 2, which is not a limitation. The eaves-side fastening device 4 may include two engaging portions 72, as shown in FIG. 26.

In the first to fifth embodiments, the biasing portions 44, 44A, 44C, and 44D have been described as having a restorative force for returning the regulating portions 61, 61A, and 61B from the first state P1 to the second state P2. The configuration, however, is not limited thereto. In a different example, the biasing portions 44, 44A, 44C, and 44D may not be given a restorative force.

In addition, the fastening devices 3 and 3A of the first, second, and fifth embodiments have been described as including the base member 20 as an example, which is not a limitation. For example, if the upper surface of the roof 200 is a flat surface as in the third and fourth embodiments, the fastening devices 3 and 3A in the first and second embodiments may adopt the base member 20B for the fastening devices 3B and 3C in the third and fourth embodiments in place of the base member 20.

In addition, the fastening devices 3B and 3C of the third and fourth embodiments have been described as including the base member 20B, which is not a limitation. For instance, if the roof 200 is not flat due to the roofing members 201 as in the first and second embodiments, the fastening devices 3B and 3C of the third and fourth embodiments may adopt the base member 20 of the fastening devices 3 and 3A of the first and second embodiments in place of the base member 20B.

In addition, in the first to fifth embodiments, a configuration has been described in which the bolt 24 is adopted as an exemplary fastening member having a shaft portion and fastening the fastening tool 6 and the pressing members 23, 23A, 23B, and 23C to the base members 20 and 20B, which are the mounting target objects. The present invention, however, is not limited thereto. For example, the fastening member may be configured to include a shaft portion and no nut, and the fastening tool 6 and the pressing members 23, 23A, 23B, and 23C may be fastened to the base members 20 and 20B by inserting the shaft portion into the base members 20 and 20B.

The present invention is not limited to the above-described embodiment, and various other modifications can be made without departing from the gist of the present invention at an implementation stage. The embodiments may be suitably combined with one another, and in such a case, combined effects can be achieved. Furthermore, various inventions are included in the above-described embodiments, and various inventions can be extracted through a combination of selected disclosed structural elements. For instance, even if some of the structural elements are omitted from the elements shown in the embodiment, the configuration without these structural elements can be extracted as an invention as long as the problem can be solved and the effects can be attained.

### REFERENCE SIGNS LIST

1, 1A, 1B, 1C Photovoltaic power generation system
2 Photovoltaic module
3, 3A, 3B and 3C Fastening device
6 Fastening tool
20 Base member
20B Base member
21 Fastening member
22, 22D Support member
23, 23A, 23B, 23C Pressing member
24 Bolt
24a Head portion
24b Base portion
24c Screw portion
25 Nut
41 Support member base portion
42 First support portion
43 Second support portion
44, 44A, 44C, 44D Biasing portion
45 Hole
46 Hole
47 First vertical wall portion
48 First mounting portion
49 Second vertical wall portion
50 Second mounting portion
60 Base portion
61 Regulating portion
62 First regulating portion
62a Third mounting portion
63 Second regulating portion
65 Third regulating portion
66 Fourth regulating portion
81 Interposed portion
104 Abutment portion
109 Bent portion
451 Bent portion
470 Bent portion
620 Step portion
P1 First state
P2 second state

What is claimed is:

1. A fastening tool for mounting a plate-shaped photovoltaic module on a mounting target object, the fastening tool comprising:
a support member on which the photovoltaic module is mounted, and which is arranged on the mounting target object;
a pressing member including a base portion and a regulating portion, the base portion being fastened to the mounting target object by a fastening member via the support member, and the regulating portion being provided on the base portion and configured to regulate movement of the photovoltaic module in a direction away from the mounting target object; and
a deformation portion provided between the base portion and the mounting target object in a posture of being tilted with respect to the base portion, the deformation portion being pressed and deformed by the base portion upon fastening of the base portion to the mounting target object by the fastening member and configured to bring the regulating portion to a posture for regulating the movement of the photovoltaic module in the direction away from the mounting target object.

2. The fastening tool according to claim 1, wherein
the deformation portion is configured to, prior to the fastening of the base portion to the mounting target object by the fastening member, tilt the regulating portion with respect to the posture of the regulating portion regulating the movement of the photovoltaic module and to be tilted in a direction different from a tilting direction of the regulating portion.

3. The fastening tool according to claim 1, wherein
the deformation portion is a biasing member having a restorative force.

4. The fastening tool according to claim 1, further comprising:
an interposed portion arranged between the mounting target object and the base portion,
wherein the deformation portion is provided between the base portion and the interposed portion, and
the regulating portion includes a first regulating portion and a second regulating portion, the first regulating portion being provided on the base portion and extending upward from the base portion to face a side surface of the photovoltaic module and the second regulating portion being provided on the first regulating portion to face a main surface of the photovoltaic module on a side opposite to the mounting target object.

5. The fastening tool according to claim 4, further comprising:
a support portion provided in the interposed portion and configured to support a main surface of the photovoltaic module on the mounting target object side,
wherein the first regulating portion is arranged between two adjacent photovoltaic modules, and
the second regulating portion includes a third regulating portion facing one of the two photovoltaic modules and a fourth regulating portion facing the other of the two photovoltaic modules.

6. The fastening tool according to claim 1, wherein
the fastening member includes a shaft portion, and
the deformation portion is provided between the base portion and the shaft portion.

7. The fastening tool according to claim 1, wherein
the fastening member is a bolt and a nut screwed to the bolt with the mounting target object and the base portion interposed.

8. A fastening device comprising:
the fastening tool according to claim 1; and
the fastening member and/or the mounting target object, which is a base member fastened to an installation position of the photovoltaic module.
